(19) United States
(12) Patent Application Publication
(10) Pub. No.: US 2022/0119183 A1
(43) Pub. Date: Apr. 21, 2022

(54) CONTAINER PACKAGING

(71) Applicant: Smile Group LLC, Anoka, MN (US)

(72) Inventor: Rashed Hieba, Anoka, MN (US)

(21) Appl. No.: 17/501,542

(22) Filed: Oct. 14, 2021

Related U.S. Application Data
(60) Provisional application No. 63/092,197, filed on Oct. 15, 2020.

(51) Int. Cl. B65D 81/22; B65B 7/28; B65D 25/02

(52) U.S. Cl. CPC B65D 81/22; B65D 25/02; B65B 7/28

(57) ABSTRACT

A method of packaging a container includes placing a first level of edible objects into the container at a bottom region of the container and extending around an interior perimeter of the container with end portions of such edible objects in contact with an end portion of an adjacent edible object at the interior perimeter. It also includes inserting a support mechanism into the container. The method further includes placing a second level of edible objects into the container and on top of the first level of edible objects. The support mechanism can be used to support edible objects of the second level against the interior perimeter of the container. And, the method includes introducing liquid into the container.

### RELATED APPLICATION

This application claims priority to U.S. provisional patent application No. 63/092,197, filed on Oct. 15, 2020, the contents of which are hereby incorporated by reference.

### TECHNICAL FIELD

This disclosure generally relates to container packaging and related methods. Embodiments are described herein in the context of edible object container packaging and methods that facilitate packaging edible objects in a container.

### BACKGROUND

Objects are packaged into a container to provide a means to hold such objects, for instance during storage, transportation, and shelf display of such objects. In the case of certain edible objects, liquid can also be placed into the container. The inclusion of liquid in the container with certain edible objects can help to retain flavor and reduce instances of the edible objects drying out prior to consumption. However, the inclusion of liquid may destabilize the arrangement of edible objects within the container by allowing for increased movement of the edible objects within the container, particularly when external forces are applied to the container, such as when the container is moved.

### SUMMARY

In general, various embodiments relating to container packaging and related methods are disclosed herein. In particular, embodiments are disclosed herein in the context of edible object container packaging and methods of packaging edible objects in a container.

Notably, various container packaging and related method embodiments disclosed herein can be useful, for instance, in increasing the volume of edible objects that can be packaged into a container by optimizing the use of available space within the container. And, at the same time, in embodiments where liquid is to be introduced into the container with the edible objects, embodiments disclosed herein can facilitate this increased volume of edible objects within the container while also reducing disruption to the arrangement of the edible objects within the container when liquid is included in the container. Thus, embodiments disclosed herein can increase the amount of edible objects that can be included within a container while also accounting for the presence of liquid within the container by increasing the structural stability of the arrangement of the edible objects within the container when in the presence of liquid, thereby facilitating the ability of the edible objects to substantially retain their arrangement within the container despite the presence of the liquid.

One embodiment includes a method of packaging a container. This method embodiment includes the step of placing a first level of edible objects into the container. The first level can be placed at a bottom region of the container with edible objects of the first level positioned such that the edible objects of the first level extend around an interior perimeter of the container with end portions of the edible objects extending around the interior perimeter in contact with both an end portion of one adjacent edible object and an end portion of another adjacent edible object at the interior perimeter. Placing the first level of edible objects into the container can also include placing edible objects of the first level interior to the edible objects extending around the interior perimeter. The method can additionally include inserting a support mechanism into the container. The support mechanism can be inserted into the container before, during, or after placing the first level of edible objects into the container. In instances when the support mechanism is inserted into the container during or after placement of the first level of edible objects, the support mechanism can be inserted into the container so that it is substantially interior to the edible objects extending around the interior perimeter. The method can further include placing a second level of edible objects into the container. The second level of edible objects can be placed on top of the first level of edible objects (e.g., closer to an opening of the container, at the top region of the container, than the first level of edible objects). The support mechanism can be used to support edible objects of the second level against the interior perimeter of the container. And, the method can include introducing liquid into the container. In some further embodiments, the method can also include removing the support mechanism and closing the container after removing the support mechanism.

Another embodiment includes a method of packaging a container. This method embodiment includes the steps of placing a first level of edible objects into the container, inserting a support mechanism into the container, after inserting the support mechanism into the container, introducing liquid into the container, and placing a second level of edible objects into the container. The second level of edible objects is placed on top of the first level of edible objects within the container, and the support mechanism supports at least some of the second level of edible objects against an interior perimeter of the container. The method embodiment also includes the steps of removing the support mechanism from the container, and, after removing the support mechanism, closing the container.

In a further embodiment of this method, the first level of edible objects is placed at a bottom region of the container. At least some of the edible objects of the first level of edible objects are positioned to extend around the interior perimeter of the container with end portions of the at least some edible objects of the first level of edible objects extending around the interior perimeter of the container in contact with both a first end portion of one adjacent edible object of the first level of edible objects and a second end portion of another adjacent edible object of the first level of edible objects at the interior perimeter of the container. At least some of the edible objects of the first level of edible objects are placed interior to the at least some of the edible objects of the first level of edible objects positioned to extend around the interior perimeter of the container. The support mechanism can be inserted into the container at a location interior to the at least some of the edible objects of the first level of edible objects positioned to extend around the interior perimeter of the container. The second level of edible objects can be placed on top of the first level of edible objects, and at least some of the edible objects of the second level of edible objects can be positioned to extend around the interior perimeter of the container with end portions of the at least some edible objects of the second level of edible objects extending around the interior perimeter of the container in contact with both a first end portion of one adjacent edible object of the second level of edible objects and a second end portion of another adjacent edible object of the second level of edible objects at the interior perimeter of the container.

In a further embodiment of this method, the support mechanism is inserted into the container after at least some of the first level of edible objects is placed into the container and before placing the second level of edible objects into the container. The liquid can be introduced into the container after the first level of edible objects is placed into the container and before placing the second level of edible objects into the container. The support mechanism can contact at least some of the edible objects of the second level of edible objects so as to apply a force at the at least some of the edible objects of the second level of edible objects to retain the at least some of the edible objects of the second level of edible objects against the interior perimeter of the container.

In a further embodiment of this method, the support mechanism includes a shaft and a support flange, and the support flange is coupled to the shaft and extends radially outward from a central longitudinal axis of the shaft. The support flange is configured to contact, at the same time, multiple edible objects positioned against the interior perimeter of the container. The support flange can include a series of recesses defined along an outer perimeter of the support flange, and each recess of the series of recesses is sized so as to receive one edible object at the recess, and the outer perimeter of the support flange, adjacent each recess of the series of recesses, is configured to extend in between adjacent edible objects in the container. The support flange can further include a plurality of liquid passage apertures defined at the support flange. The plurality of liquid passage apertures can be defined at the support flange at a location on the support flange between the shaft and an outer perimeter of the support flange such that the plurality of liquid passage apertures are bounded by the outer perimeter of the support flange.

In a further embodiment of this method, after inserting the support mechanism into the container and introducing liquid into the container, liquid is passed from a bottom region of the container through the support mechanism via a plurality of liquid passage apertures defined at a support flange of the support mechanism. After the edible objects of the first level of edible objects are positioned to extend around the interior perimeter of the container, the support mechanism can be raised within the container such that the support flange of the support mechanism is positioned above the first level of edible objects.

A further embodiment includes a container packaging. This container packaging embodiment includes a container, a first level of edible objects within the container, a second level of edible objects within the container, and liquid within the container. The first level of edible objects can include a first plurality of edible objects at a bottom region of the container. The first level of edible objects is arranged such that a first level first edible object, having a first level first edible object first end portion and a first level first edible object second end portion opposite the first end portion, is in contact with each of a first level second edible object first end portion and a first level third edible object second end portion. Each of the first level first edible object, first level second edible object, and first level third edible object extends around (e.g., and contact) an interior perimeter of the container. The first level of edible object can further include a plurality of first level interior edible objects that are positioned within the container at a region bounded by, and interior to, the first level first edible object, first level second edible object, and first level third edible object. The second level of edible objects is positioned on top of the first level of edible objects (e.g., closer to an opening of the container, at the top region of the container, than the first level of edible objects). The second level of edible objects can be arranged as described for the first level of edible objects. The liquid can be included within the container at voids between the edible objects of each of the first and second levels of edible objects.

An additional embodiment includes a container packaging. This container packaging embodiment includes a container, a first level of edible objects within the container, a second level of edible objects within the container, and liquid included within the container. The first level of edible objects includes a first plurality of edible objects at a bottom region of the container. The first plurality of edible objects of the first level includes a first level first edible object having a first level first edible object first end portion and a first level first edible object second end portion opposite the first end portion. The first level first edible object is in contact with each of a first level second edible object first end portion and a first level third edible object second end portion, and each of the first level first edible object, first level second edible object, and first level third edible object extends around an interior perimeter of the container. The second level of edible objects includes a second plurality of edible objects positioned on top of the first level of edible objects. The liquid is included within the container at voids between the edible objects of each of the first level of edible objects and the second level of edible objects.

In a further embodiment of this container packaging, the second plurality of edible objects of the second level includes a second level first edible object having a second level first edible object first end portion and a second level first edible object second end portion opposite the first end portion. The second level first edible object is in contact with each of a second level second edible object first end portion and a second level third edible object second end portion, and each of the second level first edible object, second level second edible object, and second level third edible object extends around the interior perimeter of the container. The first level of edible objects can further include a plurality of first level interior edible objects that are positioned within the container at a region bounded by, and interior to, the first level first edible object, the first level second edible object, and the first level third edible object that extend around the interior perimeter of the container. The second level of edible objects can further include a plurality of second level interior edible objects that are positioned within the container at a second region bounded by, and interior to, the second level first edible object, the second level second edible object, and the second level third edible object that extend around the interior perimeter of the container. The plurality of second level interior edible objects that are positioned within the container at the second region can be on top of the plurality of first level interior edible objects.

In yet a further embodiment of this container packaging, the container packaging can also include a lid secured at a top region of the container to close an opening of the container.

The details of one or more examples are set forth in the accompanying drawings and the description below. Other features, objects, and advantages will be apparent from the description and drawings.

### BRIEF DESCRIPTION OF THE DRAWINGS

The following drawings are illustrative of particular embodiments of the present invention and, therefore, do not limit the scope of the invention. The drawings are intended for use in conjunction with the explanations in the following description. Embodiments of the invention will hereinafter be described in conjunction with the appended drawings, wherein like numerals denote like elements. The features illustrated in the drawings are not necessarily to scale, though embodiments within the scope of the present invention can include one or more of the illustrated features (e.g., each of the illustrated features) at the scale shown.

FIG. 1 is a perspective view of an embodiment of a container packaging.

FIG. 2 is a top plan view of an embodiment of a first level of edible objects placed into a container and positioned such that the edible objects of the first level extend around an interior perimeter of the container.

FIG. 3 is a top plan view of an embodiment of a support mechanism inserted into the container of FIG. 2.

FIG. 4 is a side perspective view of the embodiment of first level of edible objects placed into a container and including edible objects of the first level placed interior to the edible objects extending around the interior perimeter.

FIG. 5 is a perspective view of an embodiment of a second level of edible objects placed into the container on top of the first level of edible objects.

FIG. 6 is a perspective view of another embodiment of a container packaging.

FIG. 7 is a perspective view of yet another embodiment of a container packaging.

FIG. 8 is a perspective of yet another embodiment of a container packaging.

FIG. 9 is a flow diagram of an embodiment of a method of packaging a container.

### DETAILED DESCRIPTION

The following detailed description is exemplary in nature and is not intended to limit the scope, applicability, or configuration of the invention in any way. Rather, the following description provides some practical illustrations for implementing embodiments of the present invention. Examples of constructions, materials, and/or dimensions are provided for selected elements. Those skilled in the art will recognize that many of the noted examples have a variety of suitable alternatives.

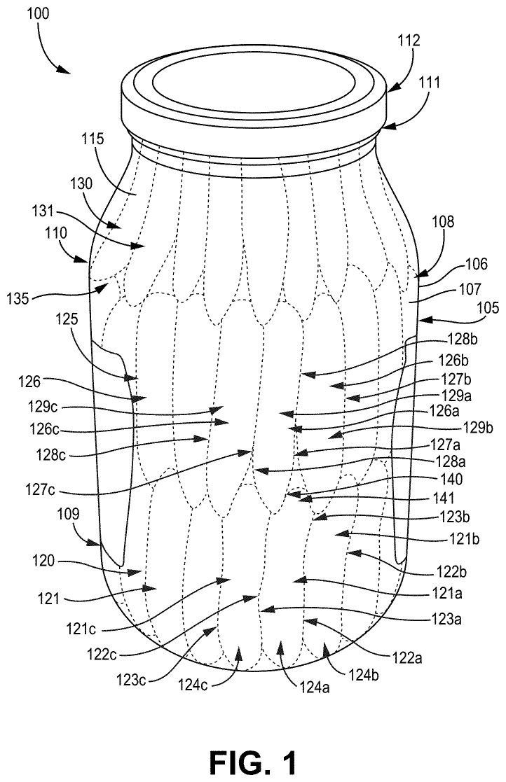

FIG. 1 shows a perspective view of an exemplary embodiment of a container packaging 100. The container packaging 100 includes a container 105. The container 105 includes an exterior surface 106 and an interior surface 107 that is opposite the exterior surface 106. The interior surface 107 defines an interior perimeter 108 of the container 105. The interior perimeter 108 defines an interior volume of the container 105. The container 105 includes a bottom region 109 and a top region 110 that is opposite the bottom region 109. The container 105 can include an opening 111 at the top region 110, and, as illustrated in the exemplary embodiment, the container 105 can include a lid 112 secured at the top region 110 of the container so as to close the opening 111 of the container 105.

The container packaging 100 includes, in the exemplary embodiment shown here, a plurality of edible objects 115 within the container 105. In particular, the container packaging 100 includes a first level of edible objects 120 within the container 105, a second level of edible objects 125 within the container 105, and a third level of edible objects 130 within the container 105. The plurality of edible objects 115 can be any of a variety of types of edible objects. The example here shows pickles as one type of the plurality of edible objects 115 within the container 105. But, in other embodiments the plurality of edible objects 115 can be any other suitable type of edible object. In various embodiments, liquid 135 is also present within the container 105 of the container packaging 100. In such embodiments, the plurality of edible objects 115 can be any type of edible object for which it is useful to package liquid with the type of the plurality of edible objects 115 inside the container 105.

As shown in the illustrated embodiment, the edible objects of each of the levels of edible objects 120, 125, 130 are arranged to extend around (e.g., and contact) the interior perimeter 108 of the container 105.

Specifically, the first level of edible objects 120 can include a first plurality of edible objects 121 at the bottom region 109 of the container 105. As shown here, a first level first edible object 121a of the first level of edible objects 120 has a first level first edible object first end portion 122a and a first level first edible object second end portion 123a opposite the first end portion 122a, a first level second edible object 121b of the first level of edible objects 120 has a first level second edible object first end portion 122b and a first level second edible object second end portion 123b opposite the first end portion 122b, and a first level third edible object 121c of the first level of edible objects 120 has a first level third edible object first end portion 122c and a first level third edible object second end portion 123c opposite the first end portion 122c. The first level of edible objects 120 is arranged such that the first level first edible object 121a is adjacent, and in many instances in contact with, each of the first level second edible object 121b and the first level third edible object 121c. In particular, the first level of edible objects 120 is arranged such that the first end portion 122a of the first level first edible object 121a is adjacent, and in many instance in contact with, the second end portion 123b of the first level second edible object 121b and the second end portion 123a of the first level first edible object 121a is adjacent, and in many instance in contact with, the first end portion 122c of the first level third edible object 121c. Each of the first level first edible object 121a, the first level second edible object 121b, and the first level third edible object 121c is arranged at the interior perimeter 108 of the container 105. Likewise, other first level edible objects can be arranged at the interior perimeter 108 of the container 105 such that edible objects of the first level 120 are arranged to extend around (e.g., and contact) the interior perimeter 108 of the container 105. This can include a front face surface 124a of the first level first edible object 121a, extending between the first end portion 122a of the first level first edible object 121a and the second end portion 123a of the first level first edible object 121a, in contact with the interior perimeter 108 of the container 105, a front face surface 124b of the first level second edible object 121b, extending between the first end portion 122b of the first level second edible object 121b and the second end portion 123b of the first level second edible object 121b, in contact with the interior perimeter 108 of the container 105, and a front face surface 124c of the first level third edible object 121c, extending between the first end portion 122c of the first level third edible object 121c and the second end portion 123c of the first level third edible object 121c, in contact with the interior perimeter 108 of the container 105.

The second level of edible objects 125 can include a second plurality of edible objects 126. As shown here, the second level of edible objects 125 can be positioned on top of the first level of edible objects 120 (e.g., closer to the opening 111 of the container 105, at the top region 110 of the container 105, than the first level of edible objects 120). For example, a lower end region 140 of one or more (e.g., each) of the second level of edible objects 125 can contact an upper end region 141 of one or more of the first level of edible objects 120. In the illustrated embodiment, the lower end region 140 of multiple second level edible objects 125 contacts, and is set between, the upper end region 141 of each of two first level edible objects 120 (e.g., such that there is an overlapping area of the lower end region 140 of second level edible object 125 and the upper end region 141 of the each of the two first level edible objects 120).

The second level of edible objects 125 can be arranged similar to that described for the first level of edible objects 120. Namely, as shown in the illustrated example, a second level first edible object 126a of the second level of edible objects 125 has a second level first edible object first end portion 127a and a second level first edible object second end portion 128a opposite the first end portion 127a, a second level second edible object 126b of the second level of edible objects 125 has a second level second edible object first end portion 127b and a second level second edible object second end portion 128b opposite the first end portion 127b, and a second level third edible object 126c of the second level of edible objects 125 has a second level third edible object first end portion 127c and a second level third edible object second end portion 128c opposite the first end portion 127c. The second level of edible objects 125 is arranged such that the second level first edible object 126a is adjacent, and in many instances in contact with, each of the second level second edible object 126b and the second level third edible object 126c. In particular, the second level of edible objects 125 is arranged such that the first end portion 127a of the second level first edible object 126a is adjacent, and in many instance in contact with, the second end portion 128b of the second level second edible object 126b and the second end portion 128a of the second level first edible object 126a is adjacent, and in many instance in contact with, the first end portion 127c of the second level third edible object 126c. Each of the second level first edible object 126a, the second level second edible object 126b, and the second level third edible object 126c is arranged at the interior perimeter 108 of the container 105. Likewise, other second level edible objects can be arranged at the interior perimeter 108 of the container 105 such that edible objects of the second level 125 are arranged to extend around (e.g., and contact) the interior perimeter 108 of the container 105. This can include a front face surface 129a of the second level first edible object 126a, extending between the first end portion 127a of the second level first edible object 126a and the second end portion 128a of the second level first edible object 126a, in contact with the interior perimeter 108 of the container 105, a front face surface 129b of the second level second edible object 126b, extending between the first end portion 127b of the second level second edible object 126b and the second end portion 128b of the second level second edible object 126b, in contact with the interior perimeter 108 of the container 105, and a front face surface 129c of the second level third edible object 126c, extending between the first end portion 127c of the second level third edible object 126c and the second end portion 128c of the second level third edible object 126c, in contact with the interior perimeter 108 of the container 105.

The third level of edible objects 130 can include a third plurality of edible objects 131. As shown here, the third level of edible objects 130 can be positioned on top of the second level of edible objects 125 (e.g., closer to the opening 111 of the container 105, at the top region 110 of the container 105, than the second level of edible objects 125). For example, the lower end region 140 of one or more (e.g., each) of the third level of edible objects 130 can contact the upper end region 141 of one or more of the second level of edible objects 125. In the illustrated embodiment, the lower end region 140 of multiple third level edible objects 130 contacts, and is set between, the upper end region 141 of each of two second level edible objects 125 (e.g., such that there is an overlapping area of the lower end region 140 of third level edible object 130 and the upper end region 141 of the each of the two second level edible objects 125). The third level of edible objects 130 can be arranged to extend around (e.g., and contact) the interior perimeter 108 of the container 105 in the same, or similar, manner as that described, and shown, for the second level of edible objects 125.

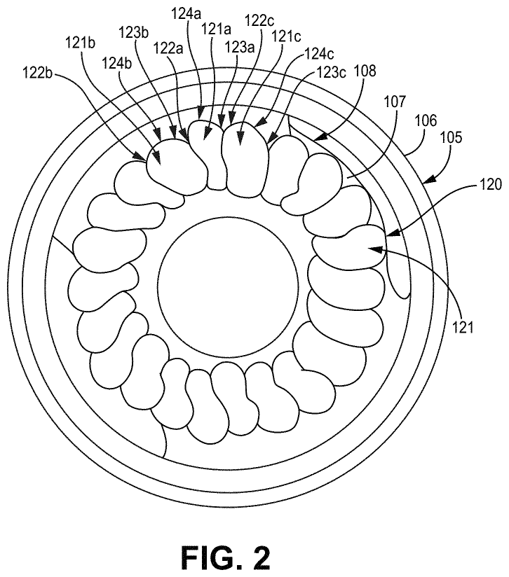

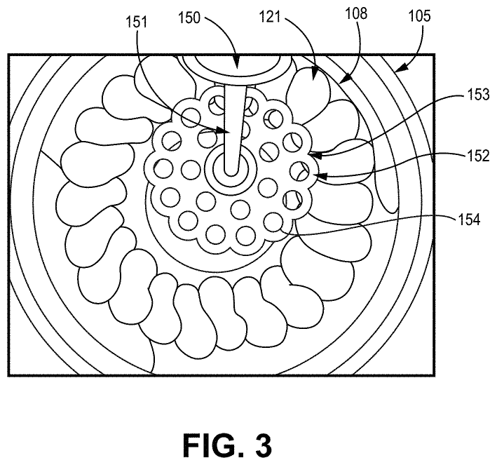

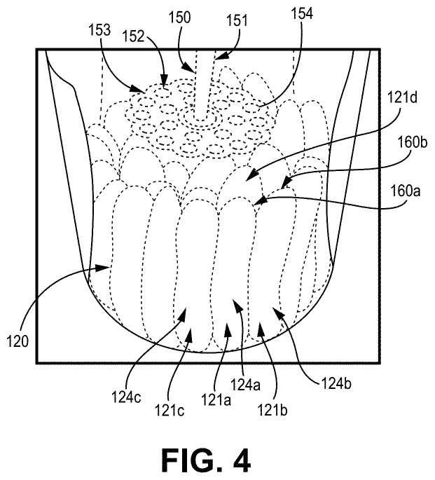

FIGS. 2-4 show the first level of edible objects 120. Specifically, FIGS. 2 and 3 shows the first level of edible objects 120 with edible objects 121 of the first level of edible objects 120 arranged to extend around, and in the example shown contact, the interior perimeter 108 of the container 105. FIG. 3 also shows an embodiment of a support mechanism 150 inserted into the container 105. And, FIG. 4 shows the first level of edible objects 120 including edible objects placed interior to the edible objects of the first level of edible objects 120 extending around the interior perimeter 108 of the container 105.

As shown in FIG. 3, the support mechanism 150 can be inserted into the container 105 and be configured to assist with supporting the edible objects as the edible objects are placed within the container 105. The illustrated embodiment of the support mechanism 150 includes a shaft 151 and a support flange 152. The support flange 152 can be coupled to the shaft 151 and extend out from the shaft 151 (e.g., extend radially outward from a central longitudinal axis of the shaft 151). The support flange 152 can be configured to contact one or more edible objects within the container 105. More specifically, as shown here, the support flange 152 can be configured to contact multiple edible objects 121 that are each positioned against the interior perimeter 108 of the container 105. As one example to facilitate this functionality, the support flange 152 can have a series of recesses 153 defined along an outer perimeter of the support flange 152. The recesses 153 can be sized so as to receive an edible object 121 thereat, and the outer perimeter surfaces at each side of each recess 153 can be configured to extend in between two adjacent edible objects 121. In the illustrated embodiment of the support mechanism 150, the recesses 153 are defined circumferentially around the outer perimeter (e.g., around the entire outer perimeter) of the support flange 152. In this way, the support mechanism 150 can be configured to support the edible objects 121 against the interior perimeter 108 of the container 105. In addition, the support flange 152 can include one or more (e.g., a plurality of) liquid passage apertures 154 defined thereat. As shown in the illustrated embodiment, the support flange 152 can include one or more of the liquid passage apertures 154 at a location on the support flange 152 between the shaft 151 and an outer perimeter of the support flange 152 such that the one or more liquid apertures 154 can be fully bounded by the outer perimeter of the support flange 152. The one or more liquid passage apertures 154 can be useful for passing liquid through the support flange 152 of the support mechanism 150. For example, when liquid is introduced into the container 105 while the support mechanism 150 is in the container 105, the liquid can pass from the bottom of the container 105, encounter the support flange 152, pass through the support flange 152 via the one or more liquid passage apertures, and then the liquid can be present above the support flange 152 within the container 105.

As shown in FIG. 4, the first level of edible objects 120 can further include a plurality of first level interior edible objects 121d. The plurality of first level interior edible objects 121d can be positioned within the container 105 at a region bounded by, and interior to, the first level first edible object 121a, first level second edible object 121b, and first level third edible object 121c. For instance, one of the first level interior edible objects 121d can contact a rear face surface 160a of the first level first edible object 121a and/or a rear face surface 160b of the first level second edible object 121b. In the illustrated example, the one of the first level interior edible objects 121d contacts both the rear face surface 160a of the first level first edible object 121a and the rear face surface 160b of the first level second edible object 121b. The rear face surface 160a can extend between the first end portion 122a of the first level first edible object 121a and the second end portion 123a of the first level first edible object 121a and be opposite the front face surface 124a that interfaces with the interior perimeter 108, and the rear face surface 160b can extend between the first end portion 122b of the first level second edible object 121b and the second end portion 123b of the first level second edible object 121b and be opposite the front face surface 124b that interfaces with the interior perimeter 108. The plurality of first level interior edible objects of the first level of edible objects 120 can be positioned within the container 105 such that the plurality of first level interior edible objects are spaced apart from the interior perimeter 108 and there is generally an edible object interfacing with the interior perimeter 108 (e.g., the first level first edible object 121a) between the plurality of first level interior edible objects and the interior perimeter 108.

As seen in FIG. 4, the support mechanism 150 can be moved within the container 105 to facilitate (e.g., make room for) the plurality of first level interior edible objects. As one such example, after the first level edible objects are placed at the interior perimeter 108, the support mechanism 150 can be raised within the container 105 so that the support flange 152 is positioned above the first level of edible objects 120. More specifically, in one example, after the first level edible objects are placed at the interior perimeter 108 and some of the plurality of first level interior edible objects are placed interior to those at the interior perimeter 108, the support mechanism 150 can be raised within the container 105 so that the support flange 152 is positioned above the first level of edible objects 120 to allow the remainder of the plurality of first level interior edible objects to be placed at the first level. Raising the support flange 152 to be positioned above the first level of edible objects 120 can include positioning the support flange 152 above the upper end region 141 of one or more (e.g., each) of the first level of edible objects 120.

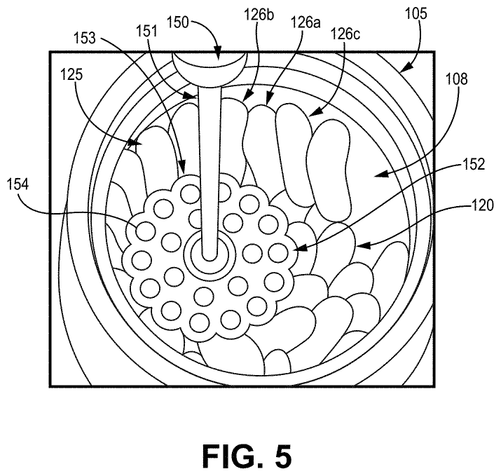

FIG. 5 shows the second level of edible objects 125 being placed into the container 105 on top of the first level of edible objects 120. In the illustrated example, the support mechanism 150 is used to facilitate placement of edible objects of the second level of edible objects 125 at the interior perimeter 108 of the container 105. In particular, one or more of the recesses 153 at the support flange 152 can receive thereat a rear face surface of an edible object of the second level of edible objects 125 that at its opposite front face surface interfaces with (e.g., contacts) the interior perimeter 108. And, the outer perimeter surfaces at each side of each recess 153 can be configured to extend in between two adjacent edible objects of the second level of edible objects 125 each positioned to interface with the interior perimeter 108. As additional edible objects of the second level of edible objects 125 are positioned at the interior perimeter 108, the support mechanism 150 can be moved appropriately to support additional edible objects of the edible objects of the second level of edible objects 125 at the interior perimeter 108 until the interior perimeter 108 is generally covered by edible objects at a height of the second level of edible objects 125. And, as with placing the first level of edible objects 120, the support mechanism 150 can be moved within the container 105 to facilitate (e.g., make room for) a plurality of second level interior edible objects. The plurality of second level interior edible objects can be placed in a manner similar to, or the same as, that described previously with respect to the plurality of first level interior edible objects. Namely, the second level interior edible objects can be positioned within the container 105 at a region bounded by, and interior to, the second level first edible object 126a, second level second edible object 126b, and second level third edible object 126c. For instance, one of the first level interior edible objects can contact a rear face surface of the second level first edible object 126a and/or a rear face surface of the second level second edible object 126b.

Additional levels of edible objects can be placed into the container 105 in a manner as described for the first and second levels of edible objects 120, 125. For example, the exemplary container 105 shown here includes the third level of edible objects 130. The third level of edible objects can be placed within the container 105 as described for the first and second levels of edible objects 120, 125.

Liquid can be included within the container 105. For example, during or after placement of one or all of the level of edible objects 120, 125, 130, liquid can be introduced into the container 105. The liquid can, for example, fill voids between the edible objects of each of the first, second, and third levels of edible objects 120, 125, 130. For instance, once the first, second, and third levels of edible objects 120, 125, 130 have been placed in the container 105, including placement of both the edible objects at and around the interior perimeter 108 and the interior edible objects of each level, liquid can be introduced into the container 105 so as to fill the voids between the edible objects of each of the placed first, second, and third levels of edible objects 120, 125, 130. By introducing liquid into the container either after a particular level has finished being placed or after all level have finished being placed, the liquid introduction may be less likely to disrupt the arrangement of the edible objects as placed at each of the first, second, and third levels of edible objects 120, 125, 130. After a desired amount of liquid has been introduced within the container 105, the lid 112 can be secured to the container 105 so as to close the container 105.

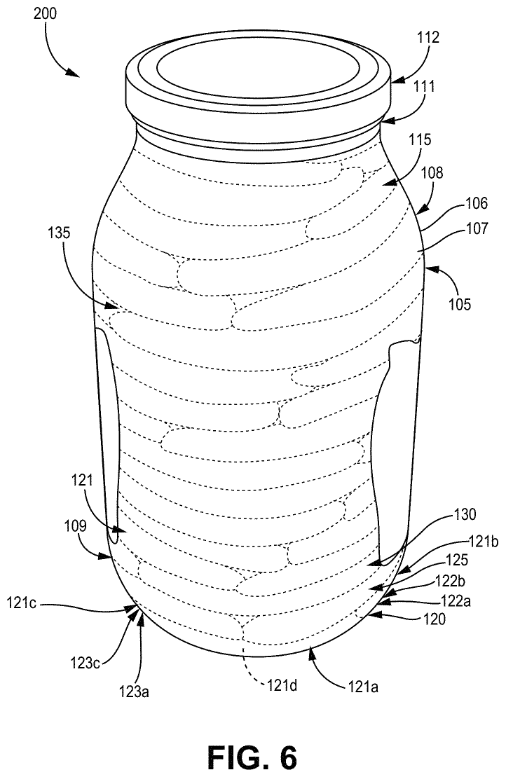

FIG. 6 shows another embodiment of a container packaging 200. The container packaging 200 is similar to the container packaging 100 except that the plurality of edible objects 115 (e.g., pickles) within the container 105 in the container packaging 200 are oriented ninety degrees relative to the orientation of the plurality of edible objects 115 of the container packaging 100.

The container packaging 200 includes the container 105, the first level of edible objects 120 within the container 105, the second level of edible objects 125 within the container 105, and liquid 135 within the container 105. The first level of edible objects 120 includes the first plurality of edible objects 121 at the bottom region 109 of the container 105. The first level of edible objects 120 is arranged such that the first level first edible object 121a, having the first level first edible object first end portion 122a and the first level first edible object second end portion 123a opposite the first end portion 122a, is in contact with each of the first level second edible object first end portion 122b and the first level third edible object second end portion 123c. Each of the first level first edible object 121a, first level second edible object 121b, and first level third edible object 121c extends around (e.g., and contact) the interior perimeter 108 of the container 105. The first level of edible objects 120 can further include a plurality of first level interior edible objects 121d that are positioned within the container 105 at a region bounded by, and interior to, the first level first edible object 121a, first level second edible object 121b, and first level third edible object 121c. The second level of edible objects 125 is positioned on top of the first level of edible objects 120 (e.g., closer to the opening 111 of the container 105, at the top region 110 of the container 105, than the first level of edible objects 120). The second level of edible objects 125 can be arranged as described for the first level of edible objects 120. The liquid 135 can be included within the container 105 at voids between the edible objects of each of the first and second levels of edible objects 120, 125. Likewise, the third level (and above levels) of edible objects 130 can be arranged as described for the first and second levels of edible objects 120, 125, and the liquid 135 can be included within the container 105 at voids between the edible objects of each of the first, second, and third levels of edible objects 120, 125, 130.

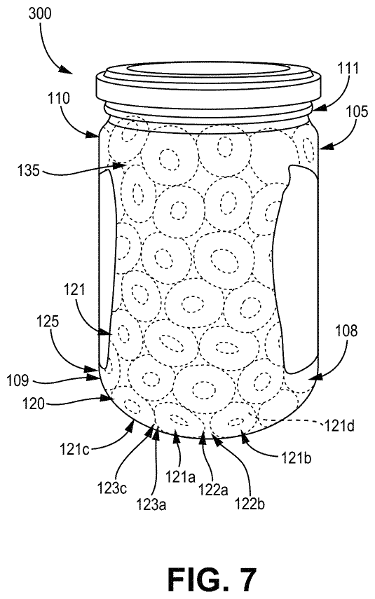

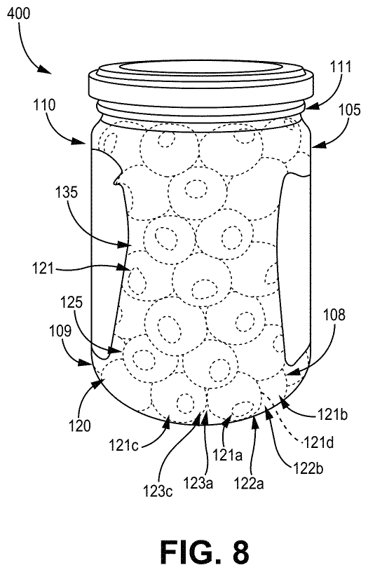

FIGS. 7 and 8 show perspective views of other embodiments of container packagings. FIG. 7 shows an embodiment of a container packaging 300, and FIG. 8 shows an embodiment of a container packaging 400. The container packagings 300, 400 include a different type of edible object than the container packagings 100, 200 described previously. Specifically, the illustrated examples of the container packagings 300, 400 include olives as the type of edible object within the container 105. The container packagings 300, 400 differ in that the olives within the container packagings 300, 400 are in different forms.

The container packagings 300, 400 include the container 105, the first level of edible objects 120 within the container 105, the second level of edible objects 125 within the container 105, and liquid 135 within the container 105. The first level of edible objects 120 includes the first plurality of edible objects 121 at the bottom region 109 of the container 105. The first level of edible objects 120 is arranged such that the first level first edible object 121a, having the first level first edible object first end portion 122a and the first level first edible object second end portion 123a opposite the first end portion 122a, is in contact with each of the first level second edible object first end portion 122b and the first level third edible object second end portion 123c. Each of the first level first edible object 121a, first level second edible object 121b, and first level third edible object 121c extends around (e.g., and contact) the interior perimeter 108 of the container 105. The first level of edible objects 120 can further include a plurality of first level interior edible objects 121d that are positioned within the container 105 at a region bounded by, and interior to, the first level first edible object 121a, first level second edible object 121b, and first level third edible object 121c. The second level of edible objects 125 is positioned on top of the first level of edible objects 120 (e.g., closer to the opening 111 of the container 105, at the top region 110 of the container 105, than the first level of edible objects 120). The second level of edible objects 125 can be arranged as described for the first level of edible objects 120. The liquid 135 can be included within the container 105 at voids between the edible objects of each of the first and second levels of edible objects 120, 125. Likewise, the third level (and above levels) of edible objects 130 can be arranged as described for the first and second levels of edible objects 120, 125, and the liquid 135 can be included within the container 105 at voids between the edible objects of each of the first, second, and third levels of edible objects 120, 125, 130.

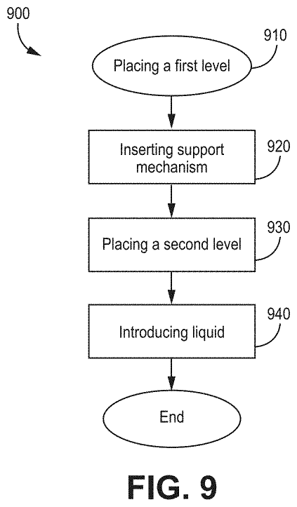

FIG. 9 is a flow diagram of an embodiment of a method 900 of packaging a container. For example, in packaging the container, the method 900 can include any one or more of the features disclosed herein with respect to the packaging containers 100, 200, 300.

At step 910, the method 900 includes placing a first level of edible objects within a container. For example, the first level of edible objects can be placed into the container as disclosed herein with respect to the first level of edible objects of any of the container packaging embodiments 100, 200, 300. Placing the first level of edible objects can include placing edible objects of the first level at the interior perimeter of the container as well as placing edible objects of the first level interior to those edible objects placed at the interior perimeter of the container.

At step 920, the method 900 includes inserting a support mechanism into the container. For example, the support mechanism can be as disclosed herein with respect to the support mechanism 150, and the support mechanism can be inserted into the container disclosed herein with respect to the container packaging embodiment 100. While insertion of the support mechanism is included at step 920, the order at which the support mechanism is inserted into the container can vary in different embodiments such that the support mechanism can be inserted into the container before, during, or after placement of the first level of edible objects within the container.

At step 930, the method 900 includes placing a second level of edible objects within the container. The second level of edible objects can be placed above (e.g., on top of) the first level of edible objects within the container. For example, the second level of edible objects can be placed into the container as disclosed herein with respect to the second level of edible objects of any of the container packaging embodiments 100, 200, 300. In some examples, the support mechanism can be used to assist with supporting the edible objects of the second level, for instance at the interior perimeter of the container, as the edible objects are placed within the container at the second level. Placing the second level of edible objects can include placing edible objects of the second level at the interior perimeter of the container as well as placing edible objects of the second level interior to those edible objects placed at the interior perimeter of the container.

At step 940, the method 900 includes introducing liquid into the container. For example, liquid can be introduced into the container during or after placement of one or more of the levels of edible objects within the container. One such example includes introducing liquid into the container after each of the levels of edible objects are placed within the container. The liquid introduced into the container can fill voids between the levels of edible objects within the container. After introducing a desired amount of liquid into the container, the container can be closed, for instance by securing a lid at an opening of the container.

Various non-limiting exemplary embodiments have been described. It will be appreciated that suitable alternatives are possible without departing from the scope of the examples described herein.

What is claimed is:

1. A method of packaging a container, the method comprising the steps of:
placing a first level of edible objects into the container;
inserting a support mechanism into the container;
after inserting the support mechanism into the container, introducing liquid into the container;
placing a second level of edible objects into the container, wherein the second level of edible objects is placed on top of the first level of edible objects within the container, and wherein the support mechanism supports at least some of the second level of edible objects against an interior perimeter of the container;
removing the support mechanism from the container; and
after removing the support mechanism, closing the container.

2. The method of claim 1, wherein the first level of edible objects is placed at a bottom region of the container, and wherein at least some of the edible objects of the first level of edible objects are positioned to extend around the interior perimeter of the container with end portions of the at least some edible objects of the first level of edible objects extending around the interior perimeter of the container in contact with both a first end portion of one adjacent edible object of the first level of edible objects and a second end portion of another adjacent edible object of the first level of edible objects at the interior perimeter of the container.

3. The method of claim 2, wherein at least some of the edible objects of the first level of edible objects are placed interior to the at least some of the edible objects of the first level of edible objects positioned to extend around the interior perimeter of the container.

4. The method of claim 3, wherein the support mechanism is inserted into the container at a location interior to the at least some of the edible objects of the first level of edible objects positioned to extend around the interior perimeter of the container.

5. The method of claim 4, wherein the second level of edible objects is placed on top of the first level of edible objects, and wherein at least some of the edible objects of the second level of edible objects are positioned to extend around the interior perimeter of the container with end portions of the at least some edible objects of the second level of edible objects extending around the interior perimeter of the container in contact with both a first end portion of one adjacent edible object of the second level of edible objects and a second end portion of another adjacent edible object of the second level of edible objects at the interior perimeter of the container.

6. The method of claim 1, wherein the support mechanism is inserted into the container after at least some of the first level of edible objects is placed into the container and before placing the second level of edible objects into the container.

7. The method of claim 6, wherein the liquid is introduced into the container after the first level of edible objects is placed into the container and before placing the second level of edible objects into the container.

8. The method of claim 6, wherein the support mechanism contacts at least some of the edible objects of the second level of edible objects so as to apply a force at the at least some of the edible objects of the second level of edible objects to retain the at least some of the edible objects of the second level of edible objects against the interior perimeter of the container.

9. The method of claim 1, wherein the support mechanism includes a shaft and a support flange, wherein the support flange is coupled to the shaft and extends radially outward from a central longitudinal axis of the shaft, and wherein the support flange is configured to contact, at the same time, multiple edible objects positioned against the interior perimeter of the container.

10. The method of claim 9, wherein the support flange includes a series of recesses defined along an outer perimeter of the support flange, wherein each recess of the series of recesses is sized so as to receive one edible object at the recess, and wherein the outer perimeter of the support flange adjacent each recess of the series of recesses is configured to extend in between adjacent edible objects in the container.

11. The method of claim 10, wherein the support flange further includes a plurality of liquid passage apertures defined at the support flange.

12. The method of claim 11, wherein the plurality of liquid passage apertures are defined at the support flange at a location on the support flange between the shaft and an outer perimeter of the support flange such that the plurality of liquid passage apertures are bounded by the outer perimeter of the support flange.

13. The method of claim 1, further comprising:
after inserting the support mechanism into the container and introducing liquid into the container, passing liquid from a bottom region of the container through the support mechanism via a plurality of liquid passage apertures defined at a support flange of the support mechanism.

14. The method of claim 13, further comprising:
after the edible objects of the first level of edible objects are positioned to extend around the interior perimeter of the container, raising the support mechanism within the container such that the support flange of the support mechanism is positioned above the first level of edible objects.

15. A container packaging comprising:
a container;
a first level of edible objects within the container, the first level of edible objects including a first plurality of edible objects at a bottom region of the container, wherein the first plurality of edible objects of the first level includes a first level first edible object having a first level first edible object first end portion and a first level first edible object second end portion opposite the first end portion, wherein the first level first edible object is in contact with each of a first level second edible object first end portion and a first level third edible object second end portion, and wherein each of the first level first edible object, first level second edible object, and first level third edible object extends around an interior perimeter of the container;
a second level of edible objects within the container, the second level of edible objects including a second plurality of edible objects positioned on top of the first level of edible objects; and
liquid included within the container at voids between the edible objects of each of the first level of edible objects and the second level of edible objects.

16. The container packaging of claim 15, wherein the second plurality of edible objects of the second level includes a second level first edible object having a second level first edible object first end portion and a second level first edible object second end portion opposite the first end portion, wherein the second level first edible object is in contact with each of a second level second edible object first end portion and a second level third edible object second end portion, and wherein each of the second level first edible object, second level second edible object, and second level third edible object extends around the interior perimeter of the container.

17. The container packaging of claim 16, wherein the first level of edible objects further includes a plurality of first level interior edible objects that are positioned within the container at a region bounded by, and interior to, the first level first edible object, the first level second edible object, and the first level third edible object that extend around the interior perimeter of the container.

18. The container packaging of claim 17, wherein the second level of edible objects further includes a plurality of second level interior edible objects that are positioned within the container at a second region bounded by, and interior to, the second level first edible object, the second level second edible object, and the second level third edible object that extend around the interior perimeter of the container.

19. The container packaging of claim 18, wherein the plurality of second level interior edible objects that are positioned within the container at the second region are on top of the plurality of first level interior edible objects.

20. The container packaging of claim 15, further comprising:
a lid secured at a top region of the container to close an opening of the container.
